(19) United States
(12) Patent Application Publication
(10) Pub. No.: US 2008/0033984 A1
(43) Pub. Date: Feb. 7, 2008

(54) SYSTEMS AND METHODS FOR DATA POINT PROCESSING

(75) Inventors: Robert M. Brinson, Rome, GA (US); Bryan Glenn Donaldson, Cumming, GA (US); Nicholas Levi Middleton, Cartersville, GA (US)

Correspondence Address: BLACK LOWE & GRAHAM, PLLC, 701 FIFTH AVENUE, SUITE 4800, SEATTLE, WA, 98104, US

(73) Assignee: Intelliscience Corporation, Atlanta, GA (US)

(21) Appl. No.: 11/733,504

(22) Filed: Apr. 10, 2007

Related U.S. Application Data
(60) Provisional application No. 60/744,591, filed on Apr. 10, 2006.
(60) Provisional application No. 60/744,659, filed on Apr. 11, 2006.

(51) Int. Cl. G06F 17/30

(52) U.S. Cl. 707/102; 707/E17.005

(57) ABSTRACT

Systems and methods for processing a data point in a selected data file. A data file is processed and value for each data point is stored in a first system cache. A data operation using a predetermined operator is executed on at least one data point. A second system cache stores the resulting data point values. A new data file is created using the stored data point values in the second system cache.

### PRIORITY CLAIM

This application claims priority to provisional patent applications 60/744,591 filed on Apr. 10, 2006 and 60/744,659 filed on Apr. 11, 2006 and both are herein incorporated by reference in their entirety.

### BACKGROUND OF THE INVENTION

With the increasing use of computers and computerized technology, the amount of information represented digitally has become enormous. Analysis of these vast quantities of digital data generally involves the recognition of known patterns.

In many cases, information that originates in a digital form is ultimately analyzed through manual review by a person, often requiring substantial training. For example, medical image analysis typically requires a high level of expertise. In order for people to interact with the volumes of digital data, the information is typically converted into a visual, audible, or other human-perceivable representation. However, during the process of translating digital data from its raw form into a convenient output form, some information can be lost. Data is often processed and filtered for presentation before analysis, losing significant information from the original data. For example, the data of ultrasound, seismic, and sonar signals are all initially based on sound. The data of each of these is typically processed into a graphical form for display, but the processing often sacrifices substantial meaning and detail for the sake of human readability.

While humans can be trained to analyze many different types of data, manual human analysis is generally more expensive than automated systems. Additionally, errors are often introduced due to the limits of human perception and attention span. The data often contains more detail than human senses can discern, and it is well-known that repetition causes errors. There is a need for a data point analysis system that analyzes a data file at the individual data point level and retains all of the necessary information at a particular data point.

### SUMMARY OF THE INVENTION

The present invention provides systems and methods for processing a data point in a selected data file. A data file is processed and value for each data point is stored in a first system cache. A data operation using a predetermined operator is executed on at least one data point. A second system cache stores the resulting data point values. A new data file is created using the stored data point values in the second system cache.

### BRIEF DESCRIPTION OF THE DRAWINGS

The preferred and alternative embodiments of the present invention are described in detail below with reference to the following drawings.

FIG. 1 shows an example system for data point processing;

FIGS. 2 and 3 show a flow diagram of an example method for data point processing;

FIG. 4, shows an example of a portion of an image file;

FIGS. 5-7 shows an example of the image file of FIG. 4 after some processing has been performed;

FIGS. 8, 9 and 11 show screen shots of an example user interface formed in accordance with an embodiment of the present invention;

FIG. 10 shows a portion of an example nine pixel image being processed;

FIG. 12 shows an x-ray before data point processing;

FIG. 13 shows an x-ray after data point processing;

FIG. 14 shows an example picture generated from the x-ray shown in FIG. 12 using known algorithms; and

FIG. 15 shows an example picture, generated from the x-ray of FIG. 15 using predefined algorithms.

### DETAILED DESCRIPTION OF THE PREFERRED EMBODIMENT

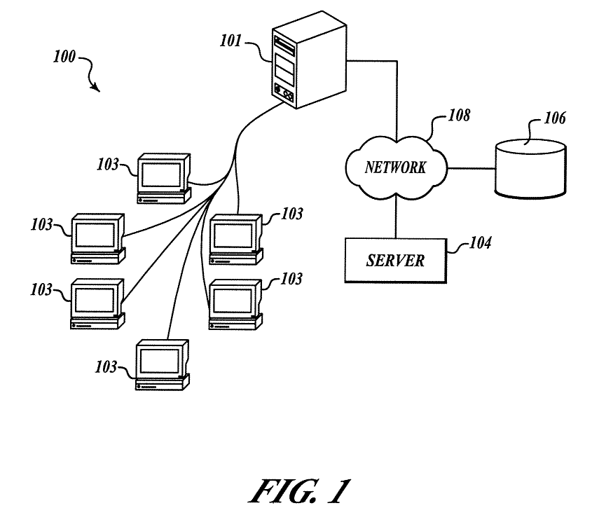

FIG. 1 shows an example system 100 for data point processing. In one embodiment, the system 100 includes a computer 101 in communication with a plurality of other computers 103. In an alternate embodiment, the computer 101 is connected with a plurality of computers 103, a server 104, a data storage center 106, and/or a network 108, such as an intranet or the Internet. Also a bank of servers, a wireless device, a cellular phone and/or another data entry device can be used in the place of the computer 101. In one embodiment, a system cache stores data point values. The cache is stored at the data storage center 106 or locally at the computer 101.

In one embodiment, an application program run by the server 104 or computer 101 creates a system cache to store the initial values for the data file. The system cache stores a value for each data point in the data file (e.g. the RGB values for a pixel).

In one embodiment, data point processing is executed on a single computer 101 connected to a plurality of computers 103, a server 104, a data storage center 106, and/or a network 108, such as an intranet or the Internet. In one embodiment, a computer loads a data file. Once the data file is loaded, the computer stores values for each data point in the data file. The value may include wavelength or RGB values of a pixel. Once each of the values is stored, a user selects on a screen what areas of the data file the user will work with. The computer then displays to the user on a graphical user interface a series of decisions. The user will select an operation, an operator, and then weight the original data point and adjacent data points. The computer, using the processor, will then manipulate each data point based on the user inputs, the resulting data points will be stored in the system cache. The computer will then rebuild the data file using the resulting data point values stored in the system cache.

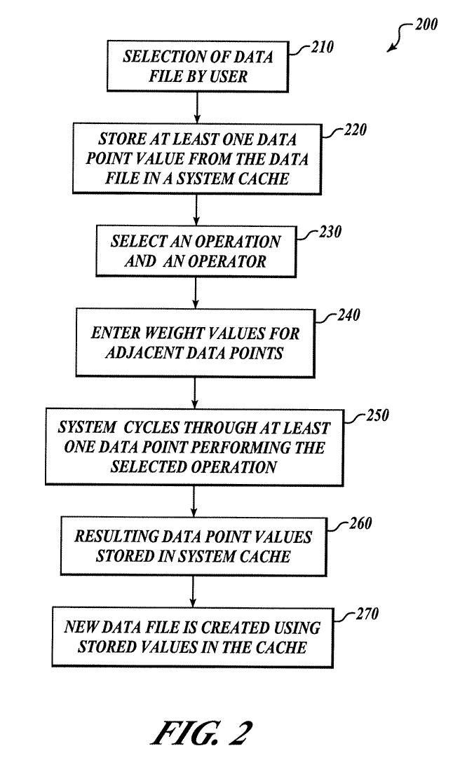

FIG. 2 shows a method 200 for data point processing. At block 210, a user selects a data file on a computer or on a network of computers. In an alternate embodiment, an automated system selects a file from a plurality of files or file types designated to be analyzed. At block 220, the system stores at least one value of a data point from data file in a system cache.

At block 230, the user selects an operation and an operator. An operation is an overarching process performed on the data. An operation can be a single process at a single time, multiple processes performed at a single time, or single or multiple processes performed in batch. In one embodiment, an operation includes but is not limited to scaling, smoothing, blurring, noise reduction, correction, replacement, restoration, equalization, and/or harmonizing. These may be used in conjunction with pure, statistical, mathematical, and/or logical algorithms. An operator is a calculation, the amount by which the system will alter each data point (e.g., split each pixel into 4 (×4), into 9, etc; condense by 4, etc; replace (mean); median; standard deviation). At block 240, a user enters weight values for adjacent data points. A user may enter the weight or allow for the system to automatically enter the weight value. The weight value is used to determine how much an original data point is altered based on the adjacent data points.

At block 250, the system cycles through at least one data point performing the selected operation using the selected operator. Cycling through in this case means that each selected data point will be manipulated in a predetermined order until all data points have been manipulated. The process may be run on a single data point, a region of interest or the entire data file. At block 260, the resulting values are stored in a system cache. At block 270, a new data file is created based on the stored data point values in the system cache.

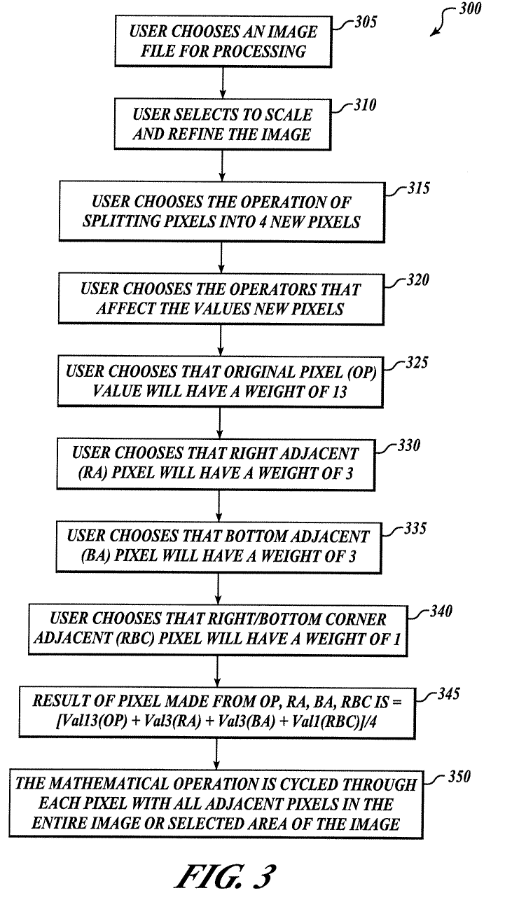

FIG. 3 shows an example process 300 of the steps described in FIG. 2. At block 305, a user chooses an image file for processing. At block 310, a user, in this example, selects to scale and refine the image. At block 315, the user chooses the operation of splitting pixels into 4 new pixels. At block 320, the user chooses the operators that affect the values of new pixels. At block 325, the user applies weight values to the original pixels in the image. In this example, the user is scaling to a larger image by splitting pixels into new ones. For a user who would want resolution as close to original as possible, the value of the original pixel would need to be larger than the sum of the other pixels being considered by a factor or exponentially. This gives extra weight to the original value, which allows the image to look the same as the size is changed. The user may not always have knowledge of how to weight, so there is often experimentation on data, but there are some common adjustments that can be assumed. This can be done in a global setting (every data point will be analyzed the same way), however, doing so independently gives users the ability to work on data dynamically, and on all the data or selections of the data as desired by the user. At block 330, the user chooses that a right adjacent pixel will have a weight of three. At block 335, the user chooses that a bottom adjacent pixel will have a weight of 3. At block 340, the user chooses that a right/bottom corner adjacent pixel will have a weight of one. At block 345, a resulting value for the target pixel is determined by the sum of the weight of the original pixel multiplied by its original value, weight of the right adjacent pixel multiplied by its original value, bottom adjacent pixel multiplied by its original value, and the right/bottom corner adjacent pixel multiplied by its original value. The sum found above is then divided by four to determine the resulting value for that pixel. At block 350, the process 300 repeats the steps in blocks 325-345 for each pixel in the data file or in a user defined region of interest.

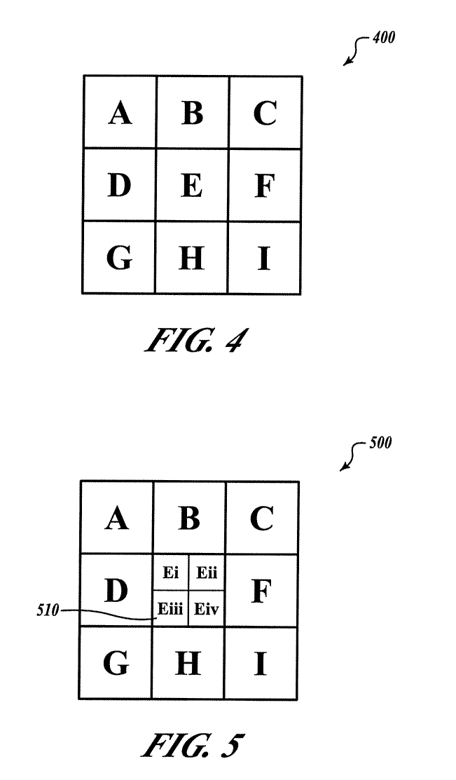

FIG. 4 shows an example 400 of an original image file, containing 9 pixels. These pixels are labeled pixels A-I. The original pixel or data point is pixel E, and each of the surrounding pixels has an effect on how pixel E is manipulated, for pixel E to be manipulated it must have all eight adjacent pixels or values for the missing pixels must be algorithmically, randomly or arbitrarily.

FIG. 5 shows an example 500 of an image file containing 9 pixels with pixel E split into 4 pixels. This is an example of how the system and method split a pixel and use the adjacent pixels to determine the values for the split pixel. Splitting into each pixel into 4 pixels first splits the original pixel into 4 pixels of the same data. These resulting pixels are made up of the original pixels value and the value of the pixels that surround that original pixel.

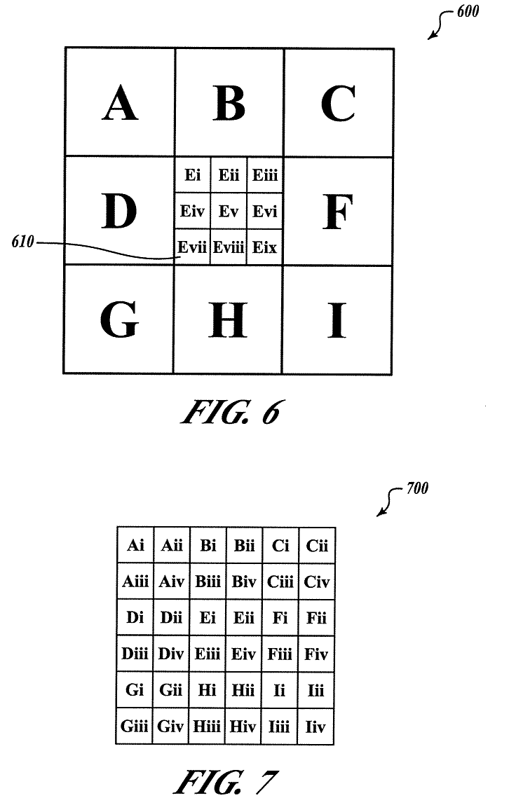

FIG. 6 shows an example 600 of an image file containing 9 pixels with pixel E split into 9 separate pixels. Pixel E is split into nine to add more data to the image file. This will allow for the image to be scaled and any number of other operations.

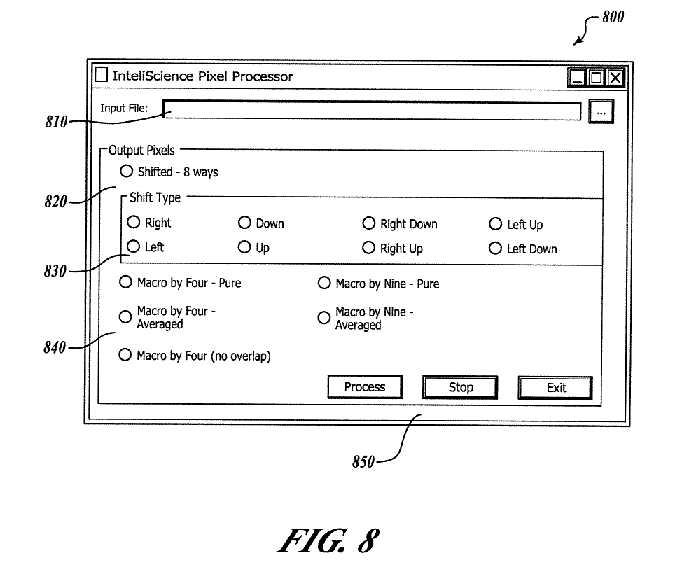

FIG. 7 shows an example 700 of the properties of an image file after processing. This example 700 shows that all pixels were split into 4 new pixels. In one embodiment when this example is expanded the image will not become blurry.

FIG. 8 shows a screen shot of an example user interface window 800. At 810, a user selects a data file stored on a computer, network, World Wide Web, a server, and or a computer input device to be processed. The user determines if the pixels should be shifted, using a shift radio button 820. The user selects how the pixels will be shifted in shift type section 830. The user selects how he/she wants to process the image by selecting one of the buttons in section 840. Buttons 850 allow for a user to stop, exit, and/or process the data.

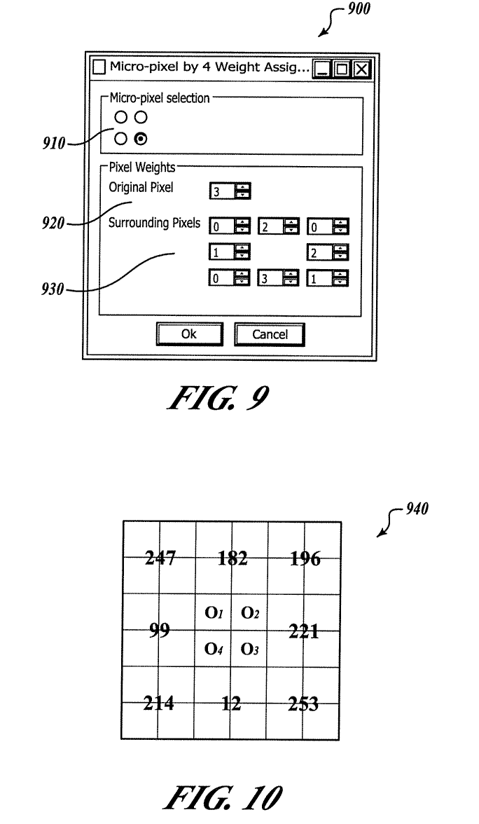

FIG. 9 is a screenshot 900 of the micro pixel weight assignment screen. At 910, a user selects which pixel to work with, in this example, O3. At area 920, the user determines what the weight of the original pixel will be. At area 930, a user assigns weight values to the surrounding pixels.

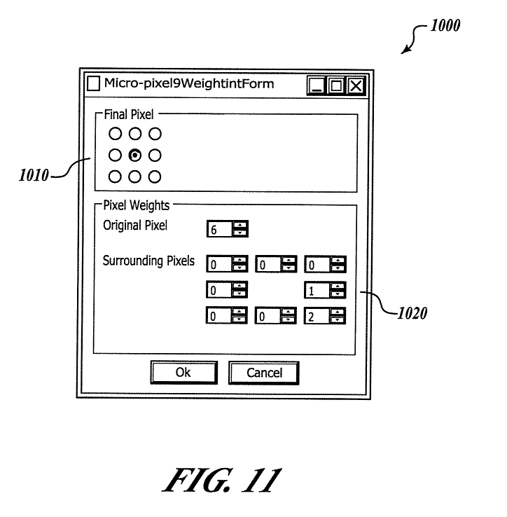

FIG. 10 shows an example 940 of a nine pixel image that is being processed in FIG. 9. In this example the values of each of the adjacent pixels to the original pixel are shown. Assuming that the original pixel has a value of 202, the value of O3 would be equal to the sum of 202 multiplied by 3, 182 multiplied by 2, 221 multiplied by 2, 253 multiplied by 1, 12 multiplied by 3 and 99 multiplied by 1. The pixels 247, 196 and 99 are not included because they have weight of 0. The sum of those numbers is then divided by 6 to get the final value of pixel O3.

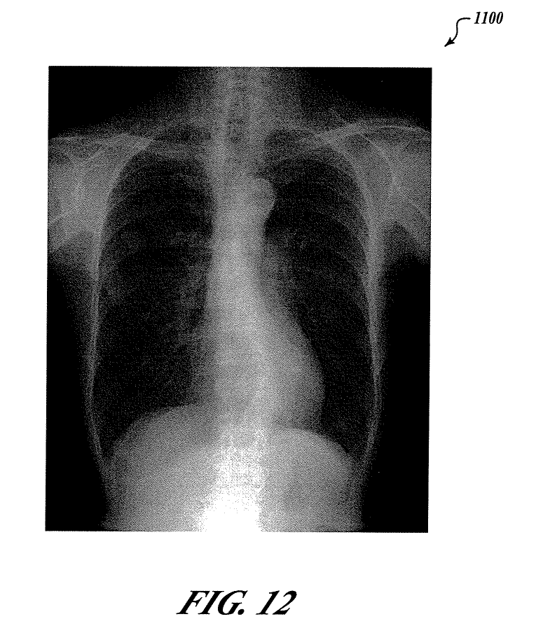

FIG. 11 shows a screenshot 1000 of a micro pixel weight assignment screen for a pixel that was split into nine. At area 1010, a user selects which pixel to weight, and in area 1020, the surrounding pixels are assigned a weight value by the user.

FIG. 12 shows an x-ray 1100 before data point processing. This x-ray looks to be black and white to the human eye, but the shades of grey in the image are what make it an important application for data point processing.

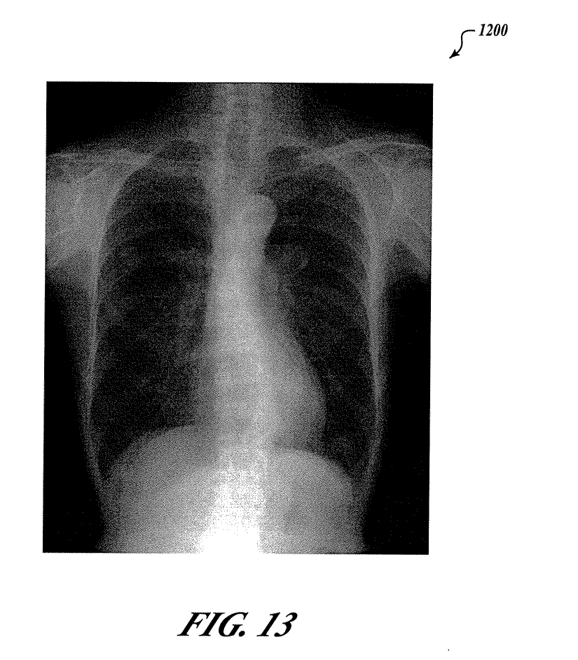

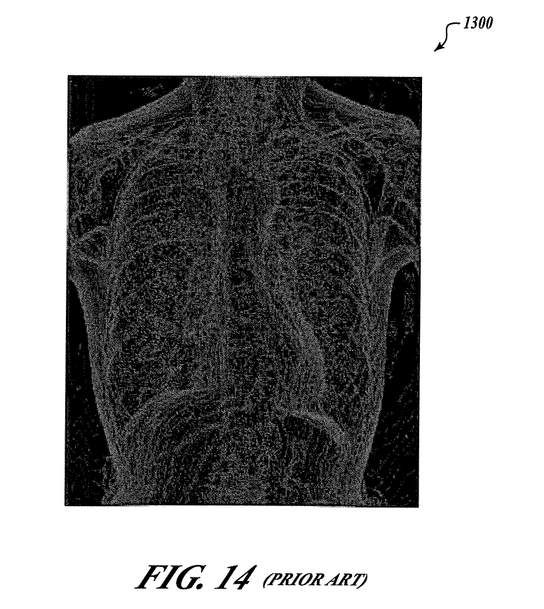

FIG. 13 shows an x-ray 1200 after data point processing. While the change may not be distinguishable to the human eye, it is very apparent when running a data transformation program. Such a program is disclosed in U.S. patent application Ser. No. 11/689,361 filed on Nov. 21, 2007 and is herein incorporated by reference in its entirety.

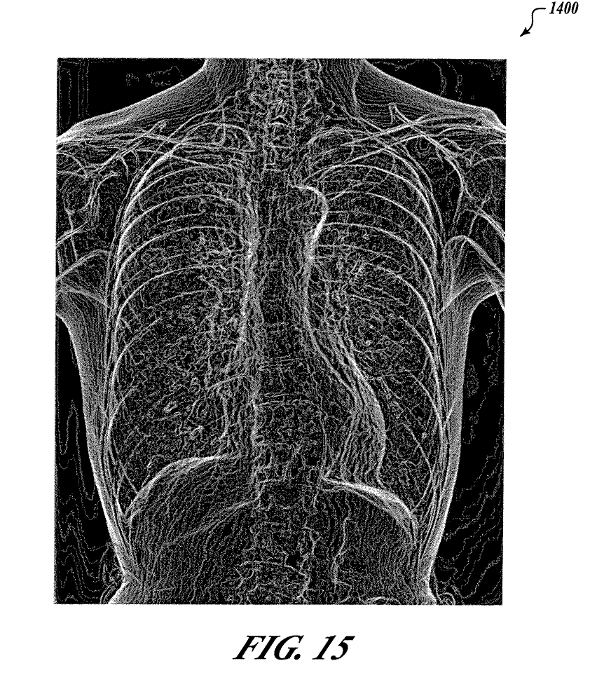

FIG. 14 shows an example picture 1300 that illustrates what is currently being used in the industry. This is the result of running data transformation on the x-ray 1100, which had not been transformed using data point processing. This image is filled with a lot of noise and distortion.

FIG. 15 shows an example picture 140 that illustrates data transformation after data point processing. The detail and clarity allows a viewer to make a clear, quick analysis.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A method for processing a data point in a selected data file, the method comprising:
processing a data file and storing a value for each data point in a first system cache;
executing a data operation, on a processor, using a predetermined operator on at least one data point;
storing resulting data point values in a second system cache; and
building a new data file using the data point values stored in the second system cache.

2. The method of claim 1, further comprising:
manipulating the new file using a data analysis software application.

3. The method of claim 2, wherein executing comprises:
prompting a user with a graphical user interface to enter a weight value for at least one data point.

4. The method of claim 3, wherein executing comprises:
prompting a user with a graphical user interface to enter a weight for adjacent data points.

5. The method of claim 4, wherein executing comprises:
applying user entered weight for at least one data point and the weight for adjacent points to the user selected operator.

6. The method of claim 5, wherein the data operation is executed on a region of interest in the data file.

7. The method of claim 6, wherein the data operation is executed on the entire data file.

8. The method of claim 7 wherein the data file is an image file.

9. The method of claim 8, wherein the data file is streaming data.

10. The method of claim 9, wherein the data file is a sound file.

11. A system for searching a plurality of data products, the system comprising:
a database configured to store significant term information for the plurality of data products;
a display; and
a processor in data communication with the display and with the database, the processor comprising:
a first component configured to process a data file and store a value for each data point in a first system cache;
a second component configured to execute a data operation using a predetermined operator on at least one data point; and
a third component configured to store a list of terms based on the calculated weight value for each term;
a fourth component configured to store the resulting data point values in a second system cache;
a fifth component configured to build a new file using the data point values in the second system cache;
a sixth component configured to manipulate the new file using a data analysis software application; and
wherein the components are located on at least one of a stand alone computer or a plurality of computers coupled to a network.

12. The system of claim 11, further comprising:
a seventh component configured to manipulate the new file using a data analysis software application.

13. The system of claim 12 further comprising:
an eighth component configured to prompt a user with a graphical user interface to enter weight value for at least one data point.

14. The system of claim 13, wherein execution comprises:
a ninth component is configured to prompt a user with a graphical user interface to enter a weight for adjacent data points.

15. The system of claim 14, wherein execution comprises:
a tenth component is configured to apply the user entered weight for at least one data point and the weight for adjacent points to the user selected operator.

16. The system of claim 15, wherein the data operation is executed on a region of interest in the data file.

17. The system of claim 16, wherein the data operation is executed on the entire data file.

18. The system of claim 17 wherein the data file is an image file.

19. The system of claim 18, wherein the data file is streaming data.

20. The system of claim 19, wherein the data file is a sound file.
